(19) United States
(12) Patent Application Publication
(10) Pub. No.: US 2009/0164544 A1
(43) Pub. Date: Jun. 25, 2009

(54) Dynamic range enhancement for arithmetic calculations in real-time control systems using fixed point hardware

(76) Inventors: Jeffrey Dobbek, Morgan Hill, CA (US); Kirk Hwang, Palo Alto, CA (US)

Correspondence Address: MARLIN KNIGHT, P. O. BOX 1320, PIONEER, CA, 95666, US

(21) Appl. No.: 12/004,138

(22) Filed: Dec. 19, 2007

(51) Int. Cl. G06F 7/487

(52) U.S. Cl. 708/503

(57) ABSTRACT

A digital processing system and method are described that encodes a fixed point number into a mantissa by removing redundant sign bits by shifting the significant bits to the left. The number of bits shifted is recorded as the exponent. In one embodiment the mantissa and exponent are combined into a single word of memory for the system which allows efficient loading of the value from memory. The mantissa and exponent can be used in multiplication calculations with a second fixed point number to achieve increased dynamic range. When the mantissa is multiplied by the fixed point number, the initial result is larger by a factor of 2^{exponent}, and a bit-shift to the right by the number of bits represented by the exponent removes this factor.

### FIELD OF THE INVENTION

The invention relates generally to methods and systems for performing arithmetic calculations in digital processing systems.

### BACKGROUND

Because calculations with floating-point numbers can require significant computing power, some digital processing systems include special hardware for performing floating-point arithmetic called floating point processors (FPP), math coprocessors, etc. However, low-cost digital signal processors, microprocessors and microcontrollers such as those used in disk drives do not have floating-point processors.

Some fixed-point processors use a modified form of integers for calculations. Numbers entered as real values are scaled by dividing by larger numbers and then rounded or truncated to an integer. The processor considers the scale value n (from number *2ⁿ) and uses this to determine the location of the fixed radix point. For example, the number 1.75 could be represented as a 4-bit integer 7 (i.e. ‘0111’) with a scale of 2. The scale value of 2 means that the first two bits are for the value (and sign for 2's complement numbers) to the left of the radix point, the third bit represents “0.5” and the fourth bit to represents “0 . . . 25”. The scale value is a shift of the radix point. A 4-bit number where the first 2 bits represent the integer portion and the second two represent the fraction is commonly referred to as a 2.2 format.

Other standard ways to represent numbers include representing floating point numbers as an “exponent”, “significand”, and “sign bit”. The encoding of a floating point number into a binary number can be done by normalizing the number by shifting the bits either left or right until the shifted result lies between 1 and 0.5 if the exponent is a power of 2. (If the exponent is a power of 16, the shifted result lies between 1 and 0.0625 ( 1/16).) A left-shift by one bit corresponds to multiplying by 2, and a right-shift corresponds to dividing by 2. The number of bit-positions shifted to normalize the number can be recorded as a signed integer. The negative of this integer (i.e., the number of bit-shifts required to recover the original number) can be defined as the base-2 exponent. Whether the right or left shift is assigned to the positive value is not significant. The normalized number between ½ and 1 is typically called the significand, because it contains the significant bits of the number. This floating point encoding is analogous to scientific notation for decimal numbers. The word mantissa is often used as a synonym for significand.

An IEEE standard defines “Fp32” as a single precision floating-point format in which a floating point number is represented by a sign bit, eight exponent bits, and 23 significand bits. The exponent is biased upward by 127 so that exponents in the range 2⁻¹²⁶ to 2¹²⁷ are represented using integers from 1 to 254. For “normal” numbers, the 23 significand bits are interpreted as the fractional portion of a 24-bit mantissa with an implied 1 as the integer portion.

Single chip digital signal processors (DSPs) are specialized microprocessors designed for fast, real-time computations. One common feature of DSPs is the “multiply and/or accumulate” instruction, or MAC. This instruction multiplies two values and stores the result in the accumulator.

U.S. Pat. No. 7,225,216 to Wyland (issued May 29, 2007) describes a floating point multiply-accumulator that uses “mantissa logic” for combining a mantissa portion of floating point inputs and “exponent logic” coupled to the “mantissa logic.” The exponent logic adjusts the combination of an exponent portion of the floating point inputs by a predetermined value to produce a shift amount and allows pipeline stages in the mantissa logic, wherein an unnormalized floating point result is produced from the mantissa logic on each clock cycle.

Published application 2006/0195497 by Dobbek, et al. (Aug. 31, 2006) describes a shift process for a digital signal processor for shifting an operand to either maximum or the minimum value depending on the bit of data input when saturation occurs. A saturation detection circuit is combined with an arithmetic shifter and a final decision multiplexor. The final decision multiplexor receives the output from the arithmetic shifter and the saturated value from the saturation circuit. When saturation is detected by the saturation detection circuit, the final decision multiplexor selects the saturate minimum or the saturate maximum depending on whether the most significant bit of the data in equals one or zero, respectively.

In published application 20060294175 Koob, et al. (Dec. 28, 2006) describe a method of counting leading zeros or ones in a data word in a digital signal processor. During operation, the execution unit can receive a data word that has a width of N bits. The execution unit can sign extend the data word to a wider temporary data word. The temporary data word can be input to a counter to count the leading zeros within the temporary data word to get a result.

In published application 0060200732 Dobbek, et al. (Sep. 7, 2006) describe a processor based nested form polynomial engine. An instruction causes a processor to set coefficient and data address pointers for evaluating a polynomial, to load a coefficient and data operand into a coefficient register and a data register, respectively, to multiply the contents of the coefficient register and data register to produce a product, to add a next coefficient operand to the product to produce a sum, to provide the sum to an accumulator and to repeat the loading, multiplying, adding and providing until evaluation of the polynomial is complete.

### SUMMARY OF THE INVENTION

The invention uses the fact that leading sign bits in the 2's compliment number system are sometimes redundant, i.e., more than one bit is used to represent the sign. These redundant sign bits reduce the dynamic range of the number. The invention extends the dynamic range by removing redundant sign bits and saving the count of bits removed as an exponent. An embodiment of the invention encodes a fixed point number into a mantissa by removing redundant sign bits by shifting the significant bits to the left. The number of bits shifted is recorded as the exponent. In one embodiment the mantissa and exponent are combined into a single word of memory for the system which allows efficient loading of the value from memory in a single fetch cycle. The mantissa and exponent can be used in multiplication calculations, for example, with fixed point numbers to achieve increased dynamic range. When the mantissa is multiplied by a fixed point number, the initial result is larger by a factor of 2^{exponent}, and a bit-shift to the right by the number of bits represented by the exponent removes this factor.

One embodiment of the invention provides a mantissa/exponent generator a microprocessor or digital signal processor that executes an instruction for encoding a fixed point number in mantissa-exponent form. Another embodiment of the invention provides an instruction implemented in a microprocessor or digital signal processor for multiplying a fixed point number by a second fixed point number encoded into the mantissa-exponent form.

### BRIEF DESCRIPTION OF THE FIGURES

FIG. 1 is a flow chart illustrating a method of converting a 2's complement number into a mantissa and exponent that are combined into in a single word stored in the system's memory according to the invention.

FIG. 2 is a flow chart illustrating a method of converting a 2's complement number into a mantissa and exponent stored in registers according to the invention.

FIG. 3 is a flowchart of an embodiment of the invention in which a number in mantissa-exponent form previously stored in memory is multiplied by a fixed point number.

FIG. 4 is a block diagram illustrating the functional components in a system implementing an embodiment of the invention for a mantissa/exponent generator that executes an instruction to count and remove redundant sign bits to derive a mantissa-exponent representation of a fixed point number.

FIG. 5 is a block diagram illustrating the functional components in a system implementing an embodiment of the invention that multiplies a fixed point number by a mantissa-exponent representation of a fixed point number.

### DETAILED DESCRIPTION OF THE INVENTION

All of the operations used in the invention as described below at run-time are fixed point operations. This allows the use of lower cost fixed point processors rather than more expensive floating point processors. Converting selected fixed point numbers into a “CTFP number” form as described herein according to the invention facilitates the run-time calculations.

In the 2's compliment number system, the sign bit is the highest order bit of the number. When the subsequent lower order bits are the same as the sign bit then there is no added information, i.e. these bits are redundant. These redundant sign bits detract from the dynamic range of the number since fixed point numbers have a fixed size in bits. The invention includes a method for counting and removing the redundant sign bits of a fixed point number in a single microprocessor instruction. The result of counting the redundant sign bits (Count) allows the shifting of the original data to the left by the number of bits in the Count (i.e. left justifying) to create a mantissa and storing the Count as a base-2 exponent in a mantissa-exponent pair. Determining in one instruction how many highest order bits are just “copies” of the sign bit allows efficient run-time construction of a new number form (mantissa-exponent) which can extend the dynamic range by the number of redundant sign bits.

The multiply and accumulation process in real-time control systems typically uses accumulators that have more bits than data words stored in memory. For example, a typical processor might use 32-bit data words and a 48-bit accumulator. When a CTFP number is formed out of a fixed point number there may only be a few bits of data left in a 32-bit number. That is, the number is small with respect to the 32-bit data. However, there may be data in the lower 16 bits of the accumulator that adds detail to the number when shifted up in the top of the accumulator. For example, suppose 0x000000018000 is in the accumulator and the fullscale of the variable represented is 64.0. (“Fullscale” is used to refer the maximum value for a variable.) The accumulator value actually represents 0x18000/2̂47*64==>44.703×10̂-9. Given data variables of 32 bits, the stored result using the uppermost 32 bits would be only 0x00000001 with an error of 50%. An embodiment of the invention allows the number to be represented with little loss of detail by the encoded 32-bit word 0x6000001E with the upper 16 bits 0x6000 being the mantissa and the lower 16 bits 0x001E being the exponent. The number in this form is (0x6000/2̂15)/2̂0x001E*64.0==>44.703×10̂-9. In this case the number is represented perfectly. The number of bits and the position of the bits for the mantissa and exponent in the encoded word can be different in other embodiments.

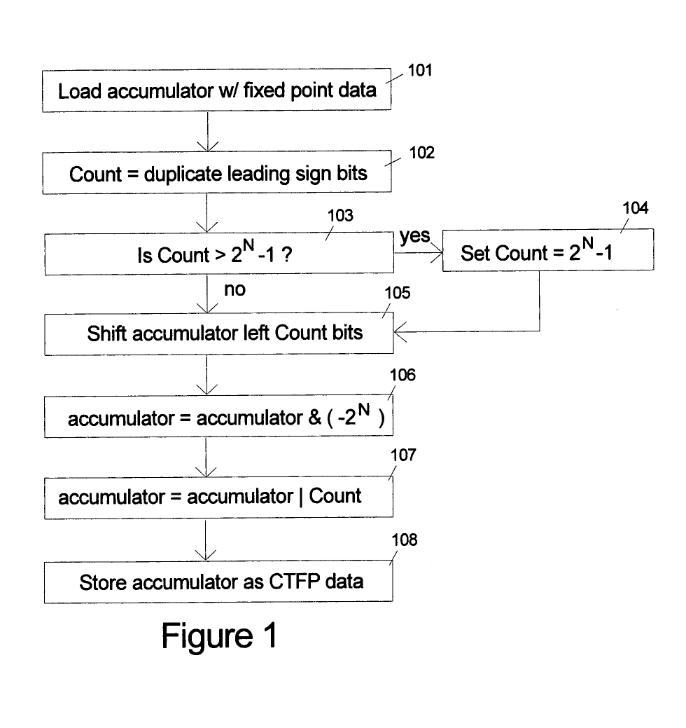

FIG. 1 is a flowchart illustrating a first embodiment of the process of converting a 2's complement fixed point number into a mantissa and exponent according to the invention. In this embodiment the mantissa and exponent are combined (encoded) into a single value that can be used immediately or stored in the system memory for subsequent use. The method can be implemented as a single instruction for a microprocessor or digital signal processor as will be discussed below. The 2's complement number to be converted is loaded into an accumulator 101. The number of duplicate sign bits (Count) are counted 102. The accumulator will typically have more bits, i.e. be wider than the 2's complement number. If the accumulator is wider than the fixed point number loaded from memory, the hardware will typically extend the sign bit into the additional bits in the accumulator in order to maintain the 2's complement format. In this case the Count can be larger than the maximum number that can be represented by the exponent of N-bits, so in this embodiment the Count is checked for being greater than exp2(N)−1 to prevent an overflow 103. (Note: The notation exp2(N) will be used herein to mean 2^{N}.) If Count is too large it is set to the maximum correct value of exp2(N)−1 104. (Note: In each of the flow charts herein the equal sign is used as an assignment operator so the expression on the right hand side is stored in the left hand variable at the end of the operation.) The data in the accumulator is then bit-shifted to the left by the value of the Count 105. This is the arithmetic equivalent of multiplying by exp2(Count). The Count is the exponent in this embodiment. The selected lower bits in the accumulator that will be used to contain the Count are zeroed by ANDing with -exp2(N) 106. The selected lower bits in the accumulator are then set to equal the Count by ORing the accumulator with the Count 107. The accumulator now contains the mantissa and exponent (Count) in a coded form that was derived from and corresponds to the original fixed point number. The mantissa/exponent portion of the accumulator is then saved in a memory location as CTFP data 108. The exact number of bits used for the mantissa and exponent and their relative positions in the accumulator can vary with the embodiment. For example, in an embodiment 16 bits might be used for the mantissa and 16 bits might be used for the exponent for convenience, but since the exponent value cannot use all 16 bits in any practical embodiment, most of the 16 bits will be unused (don't care) bits that can be used later as an extension of the mantissa in certain applications.

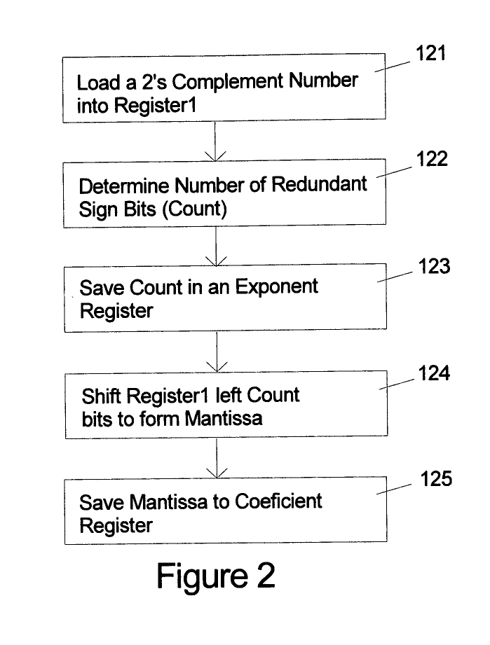

An overview of a second embodiment of the process of converting a 2's complement fixed point number into a mantissa and exponent according to the invention is shown in the flowchart of FIG. 2. The method can be implemented as a single microprocessor/DSP instruction. The 2's complement number to be converted is loaded into a selected register (register1) 121. In this embodiment the selected register preferably has the same numbers of bits as the 2's complement number, i.e. each will be the size of a word in the system. The number of redundant sign bits are counted 122. The number of redundant sign bits (i.e. Count) is saved as the exponent in an exponent register 123. The bits in register1 are then shifted to the left by the value of the exponent, i.e. Count bits 124. This is the equivalent of multiplying by exp2(Count). The shifted value is the mantissa, which can then be stored in a selected register, e.g. mantissa register 125. The mantissa and exponent values in the registers can be used immediately or be stored in memory for later use.

As an example, consider the 32 bit positive 2's complement number in hexadecimal form of 0x1312 4557. The upper byte is 0x13 (“0001 0011” in binary representation). The most significant bit (MSB) is a sign bit, and it is “0”. To eliminate redundant sign bits and to maintain the same sign, the two leading zeros in this example will be removed. The leading sign detector will return the value of 2. The 0x1312 4577 number will be shifted left by 2 bit positions to form the mantissa and the value “2” will be saved as the Count.

For an example of a negative number consider 0xF800 1234 as the input value. The upper byte is 0xF8 (1111 1000 in binary representation). The MSB is a negative sign bit of “1”. To eliminate redundant sign bits and to maintain the same sign, four leading ones in this example need to be removed. The leading sign detector will return the value of 4. The 0xF800 1234 value will be shifted left by 4 bit positions and the value “4” will be saved as the exponent.

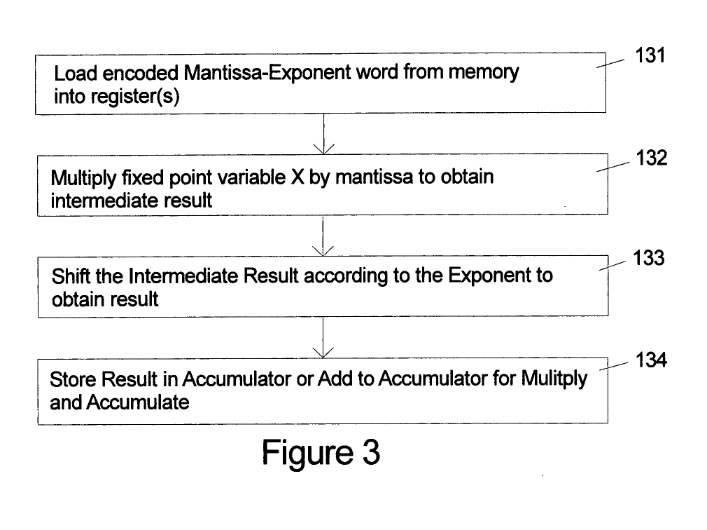

FIG. 3 is a flowchart of an embodiment of the invention in which a number y in CTFP form previously stored in memory is multiplied by a fixed point number x using a 48-bit accumulator. In this embodiment, the mantissa-exponent have been combined into a single word that can be loaded in one fetch cycle. The encoded word can be loaded into a single register or alternatively can be loaded into two registers based on the positions of the mantissa and exponent in the word 131. The fixed point number x can also be loaded from memory or may have been previously placed in a register. The mantissa component is multiplied by x to obtain an intermediate result 132. The bits in the intermediate result are shifted to the right according to the value of the exponent to obtain the desired result of x*y 133. The result (48 bits) can be stored in the 48-bit accumulator or alternatively added to the accumulator for a multiply and accumulator operation, e.g. in case of pipeline filter or vector dot product 134.

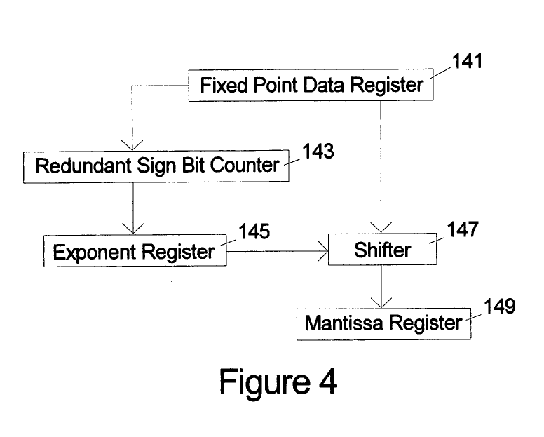

FIG. 4 is a block diagram illustrating the functional components in a mantissa/exponent generator embodiment of the invention for executing an instruction to count and remove redundant sign bits to derive a mantissa and exponent representation of a fixed point number as described above in reference to the embodiment illustrated in FIG. 2. The instruction will be called the Leading Sign-Bit Counter (LSC). The instruction can be implemented using prior art techniques for designing instructions for microprocessors or DSPs. For example, a finite state machine design can be used. As is known in the art, instructions can be architected to accept memory addresses and/or registers as parameters. Direct and/or indirect memory addressing can be used. In the embodiment shown the fixed point number that will be the operand is initially loaded into a fixed point data register 141 from memory (not shown). The LSC instruction can be architected to accept memory address or a separate instruction can be used to load the register. The redundant sign bit counter logic 143 counts the number of redundant sign bits to determine the exponent. The exponent is placed in exponent register 145 which is used by shifter 147 to shift the data in fixed point data register 141 to the left by the number of bits represented by the exponent. The shifted result in placed in mantissa register 149. At the completion of the instruction exponent register 145 and mantissa register 149 contain values that can be used immediately in subsequent instructions or saved in memory for later use.

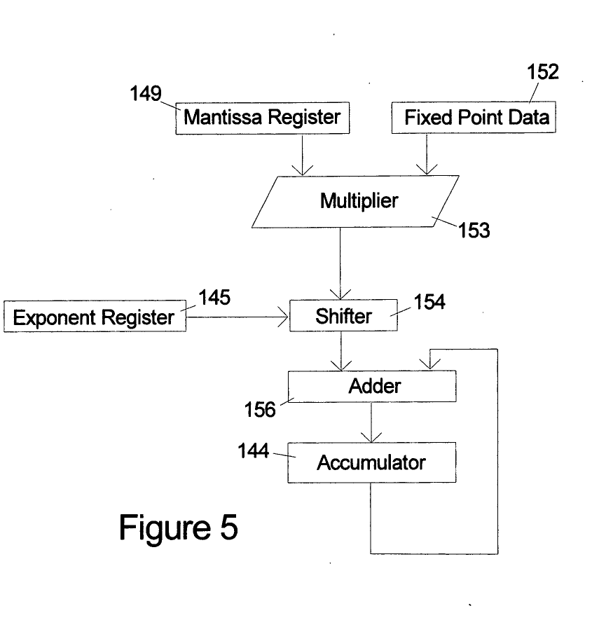

FIG. 5 is a block diagram illustrating the functional components in a system implementing an embodiment of the invention that multiplies a fixed point number (operand) by a CTFP mantissa-exponent representation of fixed point number. This embodiment implements a multiply and accumulate instruction that will be called “MAC_CTFP.” Fixed point data register 152 is loaded with a fixed point operand from memory. Mantissa register 149 contains the mantissa generated by the LSC instruction described above. Exponent register 145 contains the exponent generated by the LSC instruction described above. Alternatively the encoded mantissa/exponent representation as described above in reference to FIG. 1 could be loaded from memory and the mantissa and exponent portions could be loaded in the appropriate registers. Multiplier 153 performs the multiplication of the Mantissa register 149 and the data register 152. The result is fed to shifter 154 which uses the contents of exponent register 145 to shift the result to the right by the number of bit positions indicated by the exponent. The output from the shifter 154 is then added to the initial contents of the accumulator 144 by adder 156. The new value generated by the adder 156 is then placed in the accumulator 144 to achieve the multiply and accumulate operation.

The embodiments of the LSC and MAC_CTFP instructions described above are just one example of ways that the invention can be implemented in specific instructions. In another alternative embodiment, for example, a single instruction that performed the LSC and MAC_CTFP could be designed. The instructions can be architected to use the mantissa and exponent values combined into a single word of memory as described in reference to FIG. 1. Loop counters could also be architected into the instruction to increment index registers to achieve multiple iterations.

The foregoing description of the exemplary embodiment of the invention has been presented for the purposes of illustration and description. It is not intended to be exhaustive or to limit the invention to the precise form disclosed. Many modifications and variations are possible within the scope of the invention.

1. A digital processing system comprising:
a mantissa/exponent generator that accepts an input of a first fixed point value and produces an exponent value equal to the number of redundant sign bits in the first fixed point value and a mantissa derived by shifting bits of the first fixed point value to the left by the exponent;
a multiplier that multiplies the mantissa and a second fixed point value to form an intermediate result; and
a shifter that shifts the bits in the intermediate result to the right by the exponent to obtain the product of the first and second fixed point values.

2. The digital processing system of claim 1 further comprising an adder that adds an initial contents of an accumulator to the product of the first and second fixed point values.

3. The digital processing system of claim 1 wherein the mantissa/exponent generator further comprises means for combining the exponent and the mantissa into an encoded representation of the first fixed point value with a first group of bits in the encoded representation encoding the exponent and a second group of bits in the encoded representation encoding the mantissa.

4. The digital processing system of claim 3 further comprises means for loading the encoded representation from memory and placing the mantissa portion in a first register and the exponent portion in a second register for use by the multiplier.

5. A method of operating a digital processing system comprising:
determining an exponent as a number of redundant sign bits in a first fixed point value;
shifting the bits in the first fixed point value to the left by the exponent to form a mantissa;
combining the exponent and the mantissa into an encoded representation of the first fixed point value with a first group of bits in the encoded representation encoding the exponent and a second group of bits in the encoded representation encoding the mantissa; and
storing the encoded representation in memory.

6. The method of claim 5 further comprising multiplying a second fixed point value by the mantissa to obtain an intermediate result; and shifting the bits in the intermediate result to the right by the exponent to obtain a product of the first and second fixed point values.

7. A method of operating a digital processing system comprising:
determining an exponent as a number of redundant sign bits in a first fixed point value;
left-shifting the significant bits in the first fixed point value by the exponent to form a mantissa;
multiplying a second fixed point value by the mantissa to obtain an intermediate result; and
right-shifting the intermediate result by the exponent to obtain a product of the first and second fixed point values.
